(19) United States
(12) Patent Application Publication
(10) Pub. No.: US 2001/0041328 A1
(43) Pub. Date: Nov. 15, 2001

(54) Foreign language immersion simulation process and apparatus

(76) Inventor: Samuel Heyward Fisher, Decatur, GA (US)

Correspondence Address: SAMUEL H. FISHER, 1114 WEMBLEY DRIVE, GREENVILLE, SC, 29607, US

(21) Appl. No.: 09/853,977

(22) Filed: May 11, 2001

Related U.S. Application Data
(60) Provisional application No. 60/202,699, filed on May 11, 2000.

(51) Int. Cl. G09B 19/06

(52) U.S. Cl. 434/157

(57) ABSTRACT

A multimedia system and method simulates foreign immersion. Navigation and movement are simulated by sequentially juxtaposing virtual reality nodes and digital video segments, such that either the node or the video visually contains elements of the other. When navigated through by a computer user, a set of features augments the interactivity of navigation into a context for a simulated immersion experience.

### CROSS REFERENCE TO RELATED APPLICATIONS

This application is a continuation of Provisional Application Ser. No. 60/202,699, May 11,2000.

### BACKGROUND OF THE INVENTION

Language systems are complex environments in which people interact with visual and auditory information around them. Multimedia can be an effective learning aid, especially for learning language systems. Many aspects of a language system can be presented and represented simultaneously with multimedia. Certain levels of interactivity can provide a simulation experience. Spoken language can be heard as sounds, orthographic systems can be viewed as pictures, systems of body language can be displayed through video and diagrams, gestures can be expressed in video. Instant replaying of video allows people to automate the perception of pronunciation and facial gesturing. Still images accommodate lexical structures, which give a correlate meaning to representations in the image. And speech recognition and analysis applications allow for accuracy checking in the pronunciation of a foreign language by a non-native speaker. The ways that all of these stimuli are organized and arranged into an experience determines our interpretations and understandings of what we encounter. Because of its entertainment value and ability to draw an audience into subject matter, multimedia serves as a very effective tool in conveying information, particularly foreign language information.

Immersion is the most effective method for learning a language system. Simulation is an effective way to immerse oneself in an environment without having to leave home. Prior art in the field of educational language software neglects the importance of physical movement and orientation and does not achieve a true, immersion-level experience for a traveler or student in foreign physical environments, which accompany foreign language systems. The objective of the present invention is a gaming application that achieves a more accurate simulation of foreign language immersion. The present invention pertains to the fields of games, advertising, and education and demonstration.

### BRIEF SUMMARY OF THE INVENTION

Immersion is the most effective context in which to learn a foreign language, the ways of a culture, and the visual imagery of its geographical location. Immersion is also the only way to actually visit a foreign location. Foreign language software has made great advances in presenting information related to learning a foreign language or traveling in a foreign country. But it has yet to embrace some technological advances, which provide greater opportunities for a more realistic simulation of foreign immersion. The present invention is a computer simulation process, apparatus, and multimedia game intended for simulated, foreign travel experiences and simulated, foreign language environments. It offers the user a novel, first person, interactive perspective into an environment of a different language system. It provides a gaming context in which the user must linguistically explore, discover, and succeed in order to proceed.

Navigation and game play interaction relies partly on sequentially juxtaposing virtual reality nodes and segments of digital video such that imagery in the VR node is also contained in the beginning of the video segment. This blending effect adds visual and semantic continuity to the user's interactive and navigational experience.

The invention presents a simulated, virtual reality environment to the computer user. The user acquires linguistic ability and skills in the environment by navigating through it. The simulated environments are central to the experience as they photographically or cinematographically represent the environments of their real world counterpart. For example, if the user plays a game that simulates Japan, then the actual image data in both the VR nodes and the video segments will be photographically equivalent to some location in Japan. For instances where the distinction between actual and representative image data is not so significant, representative image data may be manufactured to accommodate the desired setting. The invention is a method and design for developing foreign travel, simulated experiences and simulated, foreign language environments. It is intended to assist its user in acquiring speaking ability and literacy skills in a foreign language system. The invention is different from prior art in that it provides a novel system for environmental, orientation and movement capacities within simulated foreign environments. The invention also enables dialogue simulations for further immersing the simulation experience. The present invention pertains to the fields of foreign language education, computer simulation technologies, and advertising as associated with international tourism. It relates to the following U.S. Patent Classifications and subclasses: 434/157, 434/309, 463/1, 463/9, 463/15, 463/23, 463/24, 463/29, 463/30-32, 463/33, 463/35, 463/47, 463/48.

The inventor of the present invention has knowledge of information contained in the following references:

Kitchens, Susan Aimee, QuickTime VR Book, The

Macromedia Press, Director 8 with Lingo: Authorized

Macromedia Press, Director 8 Lingo Dictionary

Johnson, Mark, The Body in the Mind

Lakoff and Johnson, Metaphors We Live By

direct-1@listserv.uark.edu: Apr. 12, 2000 23:47:23

direct-1@listserv.uark.edu: Jul. 27, 2000 00:37:50

WordNet release 1.6, The WordNet Glossary

QuickTime Pro

QuickTime VR Authoring Studio

The references listed above contain information pertinent to content design, as well as, to procedures for developing components of the present invention.

### BRIEF DESCRIPTION OF SEVERAL VIEWS OF THE DRAWINGS

FIG. 1 shows the graphical user interface (GUI) at its basic level, which displays (i) hyperlinks to reference aids, (ii) the first person perspective location and point of view of the user primarily comprised of a VR node or video segment, (iii) three score meters reflecting calculations of the user's character in terms of hunger, tiredness, and proven linguistic ability, and (xvi) a graphical user interface in which the user can access contents symbolically related to the hyperlink reference aids, inventory, etc. (iv) a library of inventory items acquired during the game session.

FIG. 1b shows the GUI of FIG. 1, but with different interface options and icons: (a) is the field of view (referred to in other Figures as (i)), (b) are the score meters (referred to in other Figures as (xv)), (c) the user text-input field, (d) the pop-up GUI (referred to in FIG. 1 as (xvi)), (e) links to reference aids, (f) a user voice-input activation button, and (g) a user text-input button for sending text to the application during game play.

FIG. 2 shows the use of Tool Tips in a VR node or scrolling panorama. Notice that frame 1 is only the image representing a point of view. Frame 2 introduces the cursor (x) to a location in the point of view. Frame 3 shows the Tool Tip (xi) appear in response to the cursor location. Note that the Tool Tip is in Simplified Chinese. An option for pinyin, or the romanized phonetic transcription of Chinese, appears when the user presses a key associated with that hotspot location (xii).

FIG. 3 shows hypothetical transition schemas between VR nodes (ii) and video segments (v).

FIG. 4a shows a scrolling panorama (ii) with a field of view (i) and the options of scrolling, or panning, left and right (iii) by moving the cursor in the field of view.

FIG. 4b shows the scrolling panorama with a hotspot in the field of view (iv).

FIG. 4c shows the resulting video segment after the hotspot in (iv) is selected.

FIG. 5 provides a sequence of key frames from which the consistency of visual content in a VR node merges into visual image data shared by the subsequent video segment. Frames VR 1 through VR 5 are points of view from within the VR node. VS 1 through VS 5 are keyframes in the subsequent video segment. Notice the visual continuity between the VR node and the video segment. At VR 5 and VS 1.

FIG. 5b shows the progression in the field of view from VR node to video segment.

FIG. 6 shows the flow of information in a user-character dialogue sequence. Text entered into the user text-input field (viii) is passed to a parsing table (vii) (parses primarily based on which simulated character the user is trying to converse, the phraseology of the text input, and the grammatical structure of the text input), which assesses the structure of the text and searches the Cue Points Table for a comparison between cue point naming conventions. The set of instructions then calls the best relative cue point based on its table associations, and plays that cue point's corresponding video segment “in response” to user input.

FIG. 7 depicts a hypothetical script algorithm illustrating video segment connectivity during user-character dialogue.

### DESCRIPTION OF THE PREFERRED EMBODIMENT

The game interface occupies the entirety of or part of the computer monitor display area (e.g., 800 pixels by 600 pixels). 1) The dominant area of the game display is occupied by the photographic and/or video image data, which represents the first-person perspective location and point of view of the user. This is the primary area of navigation within the game and provides the user with the visual experience of the location it represents. Other visual areas of the game interface include 2) score meters, 3) icons representing links to reference materials, 4) auxiliary display areas (e.g., Java GUI interface window) which “pop-up” into the display foreground in accordance with certain user actions, 5) text input interfaces, and 6) output transcription fields for audio language contained in video segments (i.e., a character voice output transcription field).

The theme of this game invention purports that: 1) a computer user has a simulated, continuous, first person perspective of a foreign environment, which includes image data photographically equivalent to or representative of that environment and location; and 2) the user is provided a simulation of lateral and linear mobility in and around the foreign environment.

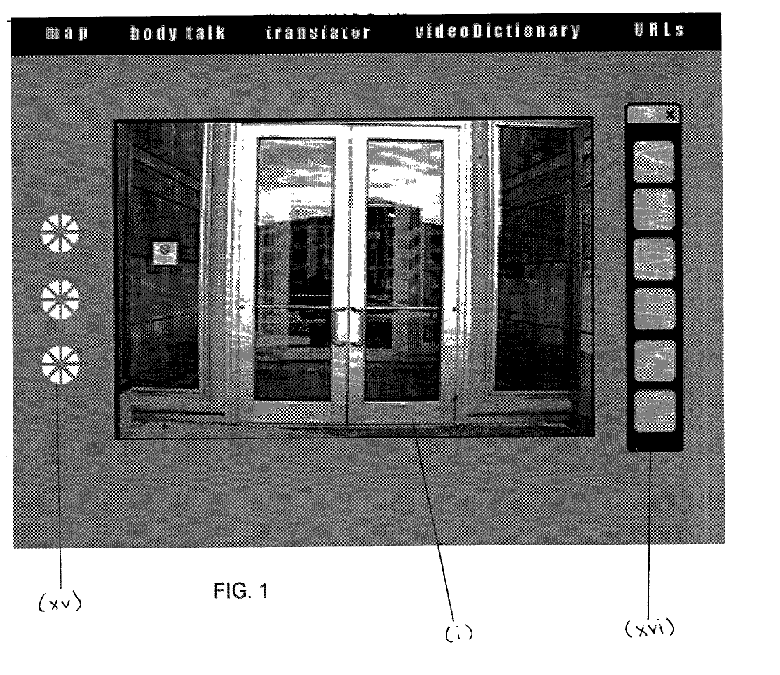

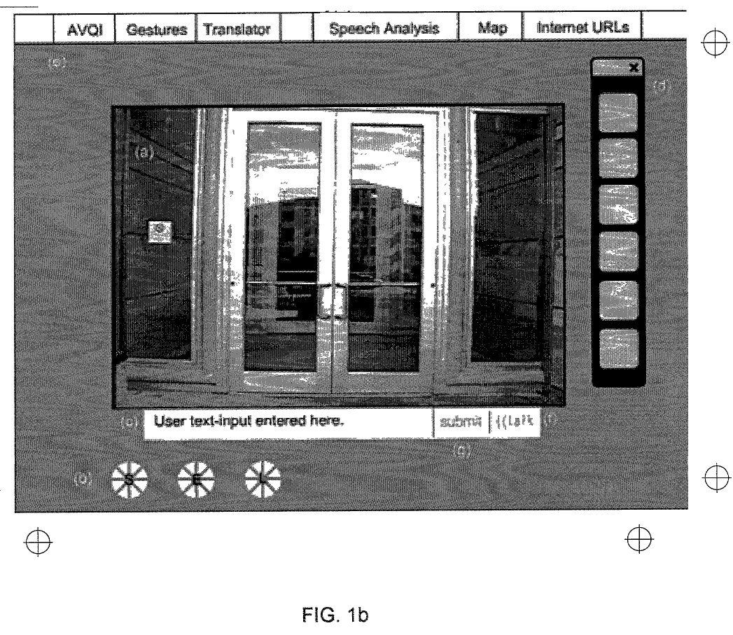

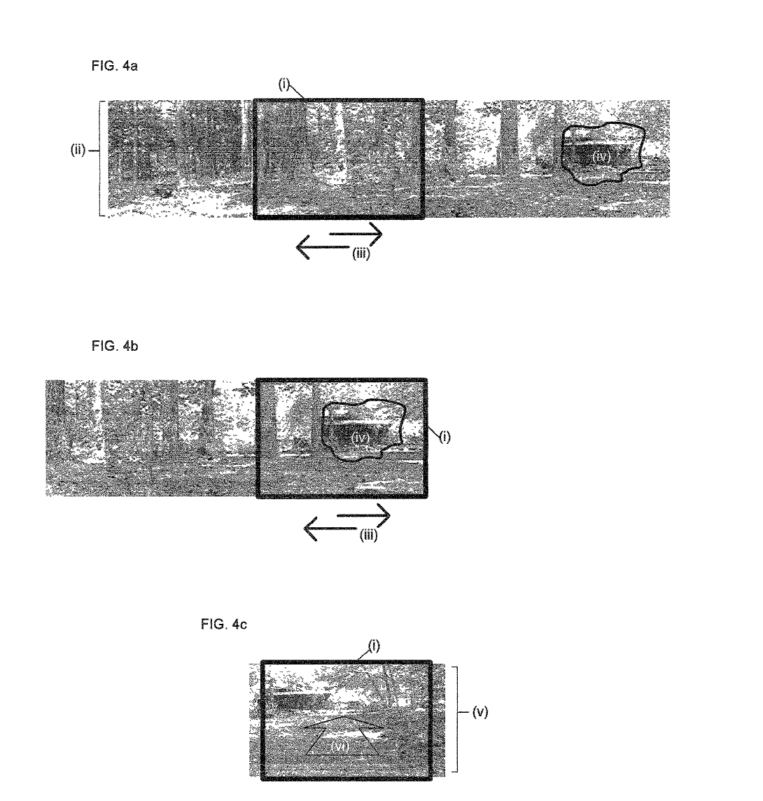

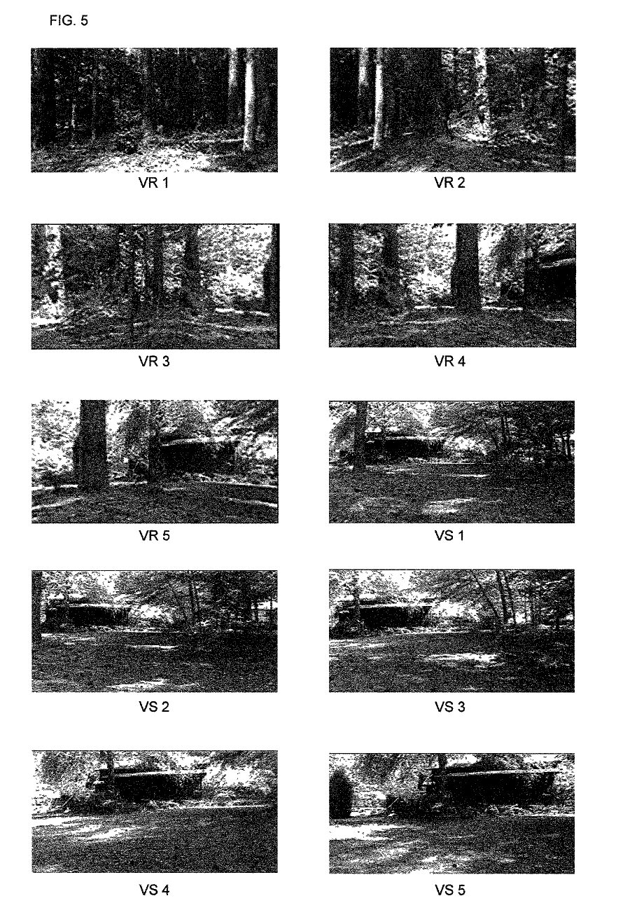

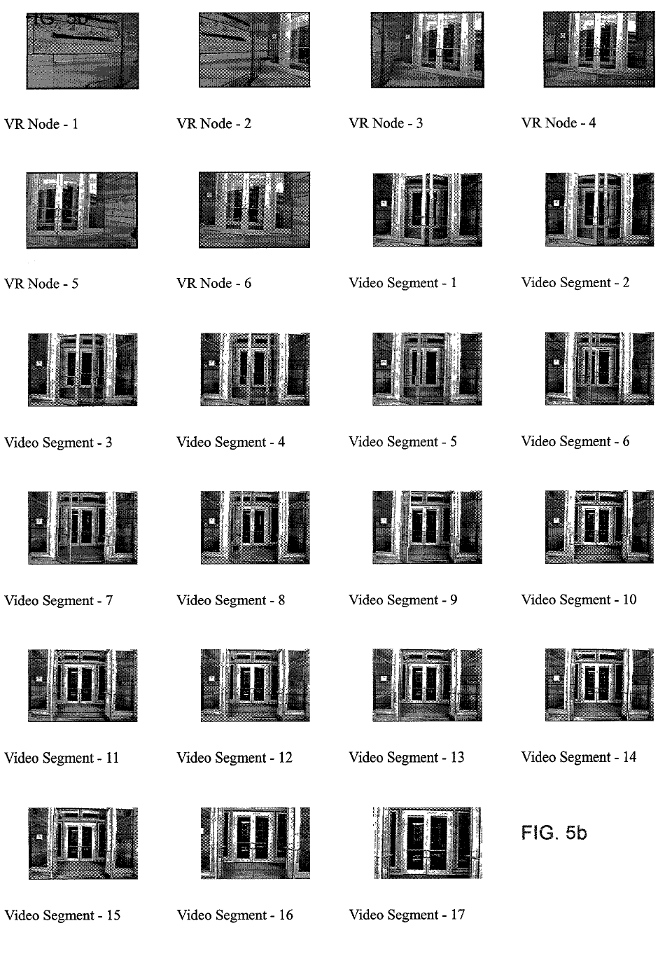

Simulation for lateral mobility is achieved by implementing VR nodes, which can also be considered scrolling panoramas. A VR panorama can be developed by arranging one, or a series, of still images which are: photographed from a single, standing location on a tripod or other rotary point or axis, and with each photograph in the series varying in horizontal degrees to the right or left, or vertical degrees up and down, from the first image photographed in the sequence of images; and which can be arranged with a multimedia authoring application or programming language such as (e.g., Apple QuickTime VR Authoring Studio; Macromedia Director; Macromedia Flash; IBM HotMedia; VRML; Java). VR Panoramas allow the user to control a dynamic field of view (FIG. 1 (i), FIG. 4 (i)) in which the user can “pan” left or right or “tilt” up or down so as to include image data in the field of view not previously viewable before the mouse or keyboard was used to enact such movements. This type of simulated, lateral mobility is commonly referred to as “VR,” or “virtual reality.” Each singular, VR location—a “node”—can include image data (a series of still images) representative of up to 360 degrees horizontally or 360 degrees vertically or both. The number of degrees inclusive in the span of the image data for one location does not have to amount to 360 degrees. The degrees of desired pan or tilt in a VR node is limited to the discretion of the developer and is circumstantial. VR is particularly important in this invention for providing the first person perspective—and user—a sense of lateral mobility.

Moreover, it is important that simulated lateral mobility be juxtaposed to simulated linear mobility in the foreign environment. Simulation for linear mobility is achieved by video as developed by: first, capturing video image data with a video recording device (e.g., digital video camera) and displaying events captured therein such that the image data in the first frame of a video sequence is also contained in one of the still images incorporated into the VR node which caused the play of the video segment, or is contained in the last frame of the previous video segment, or is inconsistent with the image data of the previous video segment. Through the use of video, a sense of linear mobility can be achieved between nodes of lateral mobility (see FIG. 4c(vi)). For some simulation arrangements, a wide-angle lens may be used for capturing digital video, and later incorporating that video dimension as a hybrid video-VR, thereby allowing the user to simultaneously experience the mobility and information flow of lateral, VR nodes and linear, video segments.

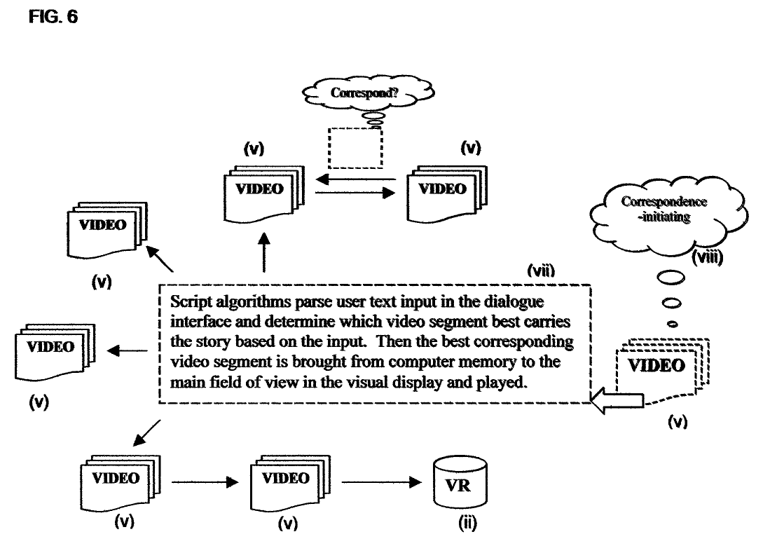

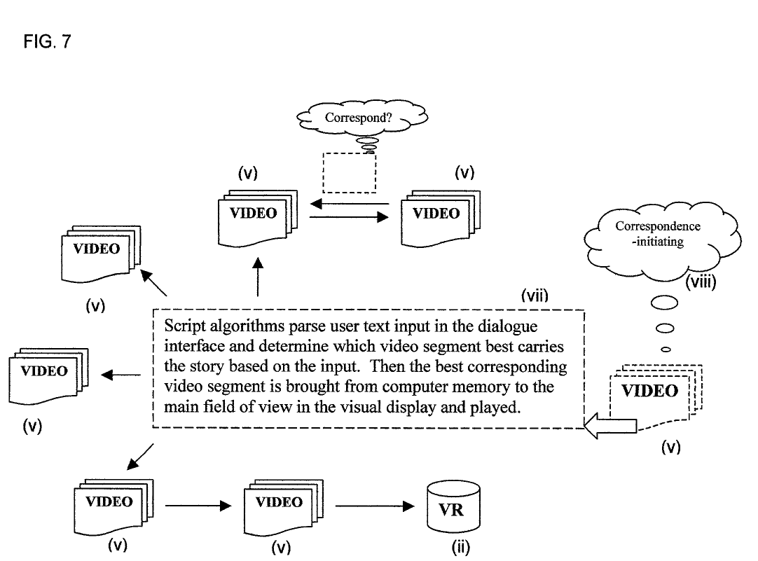

Linear mobility, embodied as video and image sequences, can also provide character engagement for the user along storylines. Video is used to simulate user-character dialogue, to communicate body language, gestures, cultural behavior (e.g., religious), pronunciation, speech, voice attributes, and complex, communicative event structures. During game play, the user interacts with characters representatively native to that foreign environment, location, and language system. Information communicated by characters in the game storyline is structured according to narrative plots, sub plots, and user input. This is to say that information communicated by characters in the game is predetermined, yet dynamically based on algorithms, and which interrelate the flow of the game, the character language, the game storyline, the sequential presentation of video (see FIG. 6), and the user's experience in the simulated foreign environment. Information communicated by characters may be segmented semantically, lexically, or grammatically or otherwise linguistically anywhere within the information interchange of a user-character dialogue. To communicate with the simulated native speakers of the foreign language, the user is enabled dynamic text fields for inputting text information according to linguistic information, which the user already knows prior to game play, or which the user has learned from storylines and interactivity previously navigated in the game. The following multimedia development process describes how the system for simulated user-character dialogue can be accomplished in production with digital video.

The first step in this production process is accomplished by video taping a character (i.e., actor), in a specific location preferred by the creative development team. While recording the performance of scripts by the actor, the actor communicates—in his/her native language system (which is different than the computer user's native language)—to the camera as though the camera were the user. Having the character talk, gesture, or otherwise communicate to the camera gives the illusion that the character is directly communicating with the user, thereby providing one aspect of a simulated first-person perspective. However, it is not necessary for the character to always face the camera (and user). For the character may express toward the camera or communicate in less direct or subtler ways. It is also intended in this invention to include conversations and dialogues with multiple characters, with which the dynamic of communication changes respective of situations created by the creative team.

The second step in the production of user-character dialogue simulation is to digitize the video or transfer the digital video content to a computer system, which is suitable for digital video editing and image editing. The third step involves segmenting the video according to content, which is based on semantic structures, grammar, gestures, and other features of communication.

The fourth step, which may be included under the third step above, is to insert “Cue Points” in the digital video time sequences. Inserting “Cue Points” can be accomplished through a variety of methods, some of which are more popularly associated with Apple QuickTime Pro and a text editor, or with “Regions” and “Markers” in the Sonic Foundry Sound Forge application program. Cue Points are added, named, and arranged by the development team according to naming conventions that express some relationship between linguistic elements in the video segments and information entered in the user input text field or the user voice-input device. Cue Points are optionally named according to instructions, database fields, or other locations in computer memory (which contain variables that have gauged the users navigation, linguistic usage and linguistic accuracy thus far in the game session and the most recent linguistic input of the user). For the purposes of developing this game, cue points relate to the semantic, lexical, and grammatical structures of the verbal information contained in the video segments, which are expressed by the simulated character.

Once the Cue Points have been added inside the Cue-Point-adding application or multimedia synchronization script (e.g., SMIL from RealNetworks), the video segments are “exported,” “saved as,” or otherwise output from the development application. The video segments with semantic, lexical, grammatical or otherwise linguistically-described, internal Cue Points reside in a directory, set of directories, or database in computer memory and can be called from a set of computer instructions as they correlate with the user correspondence input.

During the game session, the user correspondence input occurs: as text input in the user text input field, or as gestures or body language selected from a “library” of multimedia gestures and body language. Any of these types of user input are passed through sets of instructions, which identify them relative to the semantic and grammatical or otherwise linguistic identities represented in the image or audio data of the video segments. Identification of user input and it's association with the names of cue points in video segments can be determined through the incorporation of a foreign language, lexical processing application similar to WordNet Release 1.6, which draws relations between words based on the particular semantic, lexical, and grammatical comparisons of such words.

For foreign languages, which use a standard American keyboard, the user can input text directly from the keyboard. For foreign languages requiring character sets and text encoding which is different than the standard used in most American keyboards, one of two text input methods is used. One input method invokes a multimedia text input GUI (graphical user interface), which corresponds to the user's mouse and the user's keyboard. Text standards preferred for the multimedia text input GUI are UTF-8 or UTF-16, but may vary depending on the user's demographic, the availability of text input method editors specific to the foreign language (e.g., Global IME from Microsoft), and the simulation environment provided by the developers. The foreign-script-input GUI, as it can be called, resides on the game display area and can be “dragged” to different locations around the display area with the computer “mouse” device.

While the user is running the invention on a computer and is involved in a game session in the invention, the user may cause the media content in the field of view (FIG. 1 (i)) in the game display to show video in which a character is shown or appears or emerges from the image data, and in which the character may initiate communication with the user or in which, the user may initiate communication with the character. When user-character dialogue is initiated or is required for further advance in the game storyline, the video segment initiating the dialogue will idle or go into a frame set loop (based on linguistic and semantic content within the segment). This causes time for the user to input information as symbols—script, text, semantics, words, speech, utterances, iconic representations of gesture and body language, etc.—of the foreign language that the game session invoked. The user input depends on the user and may or may not relate to the context of the user's simulated environment and storyline at that time. It is preferred that the user apply his/her linguistic knowledge obtained by navigating the game in order to further his comprehension and communication skills in the foreign language and culture while simulated in the game environment.

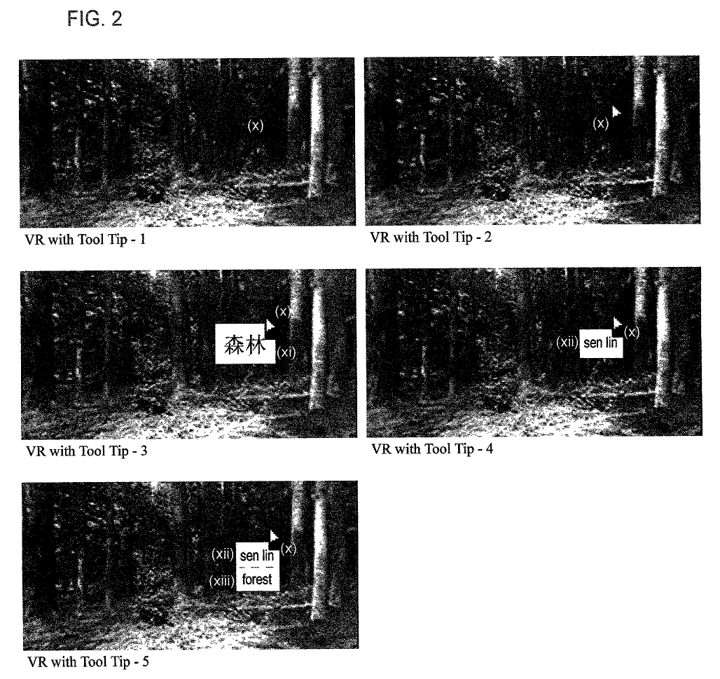

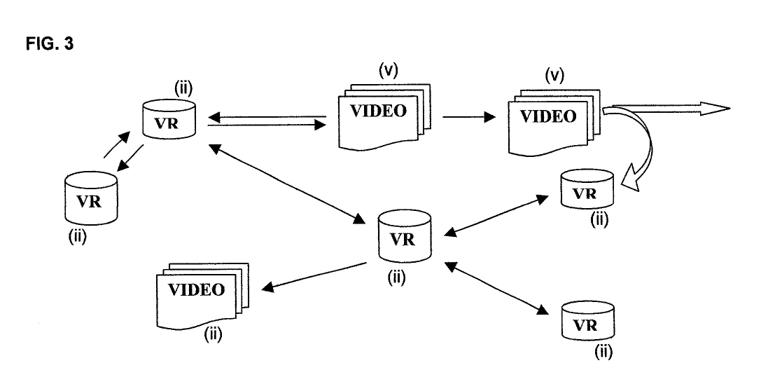

Ostensive definition accompanying respective image data plays a large role in the game. While representatively “in” a VR node or a sequence of images (video), the user can use a mouse device to rollover predetermined places in the image data of the simulated environment (FIG. 2). Such predetermined positions in the image data may cause text information to display near that mouse position and image data. This technique of informing the user with correspondent mouse positions and image data is often used in software applications to describe what utility a GUI button causes in the application (e.g., “Tool Tip” behavior properties in Macromedia Director). A similar method of describing areas of image data by way of text display near to the image data and corresponding with the mouse position is the <ALT> tag, commonly found in HTML documents. For purposes of this invention, each text display in the image data within the field of view visually expresses the meaning or definition represented in the image data whose position—correlating with the mouse—caused it to appear. Text display in this circumstance can appear as the foreign script (FIG. 2: VR with Tool Tip—3), in the orthographic system, or as written symbols associated with the foreign environment and language, or as a phonetic transcription of the sound of what the image data, representatively, is called in the foreign language and environment (FIG. 2: VR with Tool Tip—4). Moreover, when the user presses a mouse button or key while the user's mouse is over such predetermined positions in the image data, the sound representing the phonetic equivalent of what the meaningful image data is called in the foreign language follows the game application instruction to play its corresponding audio sample or clip. I call this relationship and method between mouse interactions, meaningful patterns of image data, audio data, and meaning descriptions of meaningful patterns of image data: “ostensive definition.”

Reference Resources make up another component of the game (FIG. 1b (e)). These are multimedia reference materials, which correspond to the user's simulated environment, its language system, the user's native environment, and the operation of the simulation environment. Reference resource categories include:

A) A visual, real-time, dynamic, topographical map depicting the user's current location in the simulated environment.

B) A directory of simulated inventory, in which image data representing items picked up around the simulated environment are listed, thereby providing the user the illusion of item acquisition and concept-acquisition, both of which may be necessary for task-oriented activities later in the game.

C) An audio/visual querying interface: a library comprised of video segments and image data which demonstrate linguistic concepts of a foreign language while providing the illusion that the user is remembering them from a hypothetical or simulated past experience in the foreign environment, language, and culture; an interface referencing an audio/visual library containing files, each of which exemplifies vocabulary and event structures queried by the user in the vocabulary querying interface.

D) An input translator, which translates keyed, spoken, or otherwise input vocabulary from the foreign language into the user's native language or from the user's native language into the foreign language.

E) A visual referencing aid representing a phone book, tourism brochures, advertisements and other paper-printed information.

F) One or more hyperlinks to Internet URLs serving “up-to-date” reference materials and information.

Scoring and game play are based primarily on 3 types of basic level, task-oriented activities, which permits the user to continue exploring and discovering during the computer game play. The basic level, task oriented-activities include sleeping, communicating, and eating. The basic level, task-oriented activities are represented by a visual meters which maintain current assessments of each activity level as it relates to the user's game session (FIG. 1(xv)).

For example, if the meter representing levels of restedness or sleep is too low, pre-scripted disturbances will begin to occur in the flow of the storyline and in the visual display and audio output of the game. Eventually, the user must find lodging and “sleep” or his character dies and the game session is concluded. Acquiring a place to sleep is based on proper use of the foreign language in a given situation, in which the user must communicate in the foreign language. Linguistic accuracy is instrumental in progressing and proceeding to new levels of game play. In some simulations, for example, VR hotspots (i.e., transparent, interactive buttons pre-positioned over or behind image data that activate instructional commands, media objects and/or interface elements) will not be enabled unless the user demonstrates adequate usage of a predetermined set or sets of vocabulary, grammar, or body language. In essence, this restricts the user's game simulation, which in turn, pressures the user to retain the language encountered through navigation of the environment. Moreover, users are given multiple opportunities to improve their linguistic accuracy score by returning to characters with whom they previously did not correspond well and to characters with whom correspondence went well, but whom might be able to teach a bit more of the language. Upon returning to already-visited characters, some “correspondence” scripts (see “user-character dialogue”) can expect to be a little different, but the important vocabulary and uses are still in place and instrumental for progressing in the game session.

Eating will occupy a third part of the score registry. Eating is absolutely vital to survival in any real environment, and so in the simulated environment, a timer gauges the user's energy level. A visual display is always visible for the user to assess his energy level, unless scripted to be invisible or inaccurate (possibly due to lack of sleep, etc). The user can—and sometimes must—obtain food and drink in the course of the interactive storyline in order to stay in the game. This can be done as simply as opening a refrigerator, looking inside, and selecting an item to eat or drink. In more involved scenarios of more difficult levels, the user must prepare something to eat based on kitchen operations and a recipe book. Other “eating” scenarios might involve a waiter at a restaurant, a drive through window at a fast food restaurant, or picking fruit from a tree.

The scoring system is a set of timers, each of which begin at a certain time related to the internal clock of the user's computer. Each timer is based on the computer's internal clock. When game play begins, the invention establishes a time, which corresponds to the computer's internal clock. It then adds a predetermined amount of time (minutes, seconds, and milliseconds) to the time recorded on the computer's internal clock. The sum of the two times represents zero, or “zero count.” The game application continues to read the computer's internal clock for the current time, and again, counts the difference between it and zero, and displays it as a percentage of the time between game play and the sum representing zero. In effect, as game play continues and the clock ticks down, a visual display expresses the percentage of time the user has from the time the user began to play in that round, or level, or game session. When the percentage reaches zero or the time equivalent to the sum lapses, a set of instructions and commands from within the game application will run, carrying out any one or a variety of other commands which alter play of the game.

The user can monitor the visual representation of any or all of the three visual representations of the timer percentage as the timer ticks down, and the game continues. The user can also extend the amount of time represented by any visual display by performing and completing tasks directly associated with a task timer. By selecting certain image data—which have transparent, interactive, “hotspots” or buttons overlapping the same pixel dimension as the image data—the user might be able to extend the relative timer and avoid a “zero count.” This particularly works for the sleep gauge and the eating gauge, which would require image data to be selected by way of the mouse or keys on the keyboard. It also directly relates to the linguistic accuracy score by weighing the number of ostensive definition “hits” and the number of appropriate video-dialogue inputs with what is predetermined to be acceptable. If this assessment returns that it is acceptable, the user is awarded more time for linguistic accuracy.

The user can choose to sleep, or rest his character, nearly anywhere, but there will be game play repercussions depending on where the user chooses for his character to do so. Repercussions will vary depending on the user's choice of place to sleep. This will be measured by whether or not selected image data appropriately corresponds to an acceptable place to sleep. For example, image data representing a bed is more acceptable than image data representing a wall next to a crowded street {image data is made click-able by “hotspots”}. Where a user chooses to replenish his/her sleep timer will affect the kinds of dreams the user will have while asleep.

“Dream Time” is an intermission in the continuity of game play, which executes when the user “sleeps.” Dream Time is a series of exercises, presentations, and sub-game routines, which give the user practice and information regarding the foreign language system and culture. It serves as a summary of linguistic encounters thus far experiences by the user in the game.

I, Samuel Heyward Fisher, claim:

1. A computer-implemented process wherein a sequential combination of virtual reality nodes and digital video informs a non-native speaker of a foreign language.

2. The computer-implemented process of claim 1 wherein the visual content of two virtual reality nodes are made visually continuous by the sequential display of one or more linear video segments immediately after a first node and immediately before a second node.

3. A computer simulation process wherein a sequential combination of virtual reality nodes and digital video informs the computer user of visual imagery photographically equivalent to or representative of the actual foreign language environment.

4. The computer-implemented process of claim 1 wherein a user acquires knowledge of cultural metaphors realized in a foreign language system through the presentation of or interactivity with a sequential combination of VR nodes and video segments.

5. The computer-implemented process of claim 1 wherein a user acquires knowledge of gesture practices and body language included in a foreign language system through the presentation of or interactivity with a sequential combination of VR nodes and video segments.

6. The computer-implemented process of claim 1 wherein a user acquires knowledge of ritual practices of a foreign country or culture through the presentation of or interactivity with a sequential combination of VR nodes and video segments.

7. The computer-implemented process of claim 1 wherein a user acquires knowledge of the use of foreign language orthography or writing system included in a foreign language system through the presentation of or interactivity with a sequential combination of VR nodes and video segments.

8. The computer simulation process of claim 1 wherein a user acquires knowledge of pronunciation of verbal expressions included in a foreign language system through the presentation of or interactivity with a sequential combination of VR nodes and video segments.

9. A computer-implemented process wherein a virtual reality node contains image data representative of semantically meaningful elements which,
when passed over by the cursor display of a computer mouse device, text lexically expressive of the meaning or definition represented in the image data is displayed next to or near the display location of the semantically meaningful elements of image data, and
when pressed by a cursor display of a computer mouse device, a computer instruction signals an audio sample or clip, which plays the sound representing the phonetic equivalent of what the meaningful image data is called in the foreign language.

10. The computer-implemented process of claim 9 wherein text is characteristic of the orthographic system of the foreign language.

11. The computer-implemented process of claim 9 wherein text is characteristic of an orthographic system common to the user's native language, but which describes the phonetic characteristic of the meaning of the image data as called in the foreign language.

12. A computer simulation apparatus wherein, a set of scoring features include:
Measurement of user's linguistic ability
Measurement of user's communicative effort
Measurement of recognition by the user of presented image data representing consumable goods
Measurement of recognition by the user of presented image data representing consumable goods
Measurement of recognition by the user of presented image data representing steps in mechanical operations associated with preparing consumable goods
Measurement of recognition by the user of presented image data representing an additional, ease of consumption scale for image data representing consumable goods
Measurement of recognition by the user of presented image data representing a location for sleeping
Measurement of recognition by the user of presented image data representing a location for initiating a user-character dialogue sequence
Measurement of recognition by the user of presented image data representing a location for continuing a user-character dialogue sequence

13. A set of simulation features having three types of task-oriented activities that maintain a dynamic, real-time, score account wherein,
One type of task-oriented activity measures the linguistic accuracy of user input.
One type of task-oriented activity measures a dynamic tiredness value for the user's game character.
One type of task-oriented activity measures the level of hunger for a user's game character.

14. A computer simulation apparatus by which a computer user acquires knowledge of a foreign language through a first person, simulated experience generated by a computer wherein the primary modes of user navigation and interactivity are with sequences of VR nodes and video segments in which
a VR node contains image data also contained in the first frame of a subsequent video segment, or
a video segment contains image data also contained in a subsequent VR node.

15. The computer simulation apparatus wherein a sequential combination of virtual reality nodes and digital video informs the computer user of visual imagery photographically equivalent to or representative of the actual foreign language environment.

16. The computer simulation apparatus of claim 14 wherein a user acquires knowledge of gesture practices and body language characteristic of a foreign language system through the interactive selection of an icon, which refers to a video segment wherein
the visual content of the video segment demonstrates gesture practices and body language characteristic of the foreign language system.

17. The computer simulation apparatus of claim 14 wherein the combination of features enables a user to navigate the environment represented in the game through the use of one or more official languages wherein the languages are non-native to the user's native country.

18. A computer simulation apparatus as in claim 14 wherein a user can access a computer directory containing multimedia files in which
Parts of speech indicative of a foreign language are expressed by actions performed in a video segment,
Verb meanings indicative of a foreign language are expressed by actions performed in a video segment,
Noun meanings indicative of a foreign language are expressed by actions performed in a video segment,
Adjective meanings indicative of a foreign language system are expressed by information contained in a video segment,
A grammar structure indicative of a foreign language system is defined by actions performed in a video segment,
Gesture semantics indicative of a foreign language system are defined by actions performed in a video segment,
Phrases indicative of a foreign language system are defined by actions performed in a video segment,
Idioms indicative of a foreign language system are defined by actions performed in a video segment,
Colloquialisms indicative of a foreign language system are defined by actions performed in a video segment,
Vernacular indicative of a foreign language system are defined by actions performed in a video segment,
Orthographic symbols indicative of a foreign language system are defined by actions performed in a video segment.

19. A computer-implemented simulation wherein simulation of the user sleeping involves a series of subroutines for developing skills in a foreign language.
